(19) United States
(12) Patent Application Publication
(10) Pub. No.: US 2003/0145283 A1
(43) Pub. Date: Jul. 31, 2003

(54) Customizable information processing apparatus

(75) Inventors: Isamu Machida, Nagoya (JP); Yuichi Mori, Kawasaki (JP)

Correspondence Address: McDermott, Will & Emery, 600, 13th Street, N.W., Washington, DC, 20005-3096, US

(73) Assignee: Hitachi, Ltd.

(21) Appl. No.: 10/351,337

(22) Filed: Jan. 27, 2003

(30) Foreign Application Priority Data
Jan. 28, 2002 (JP) 2002-18630(P)

(51) Int. Cl. G06F 15/00

(52) U.S. Cl. 715/513

(57) ABSTRACT

An information processing apparatus of the invention includes an execution engine 120 activated on a browser, an application browser 130, and parts 131a and 132b. The execution engine 120 reads a flow definition 14 described in XML and sequentially executes commands defined by tags included in the flow definition 14. In response to a requirement of screen display, the execution engine 120 calls the application browser 130. The application browser 130 reads a screen definition 12 and activates the respective parts 131a and 132b to create a window. The structure of the information processing apparatus has software of only basic and multi-purpose functions and utilizes electronic documents described in XML to specify the substantial specification of processing. This arrangement ensures relatively easy customization, updating, and modification of the specification of processing without any significant change of the software in the information processing apparatus.

### BACKGROUND OF THE INVENTION

1. Field of the Invention

The present invention relates to a technique of customizing the specification of information processing executed by an information processing apparatus, such as a computer.

2. Description of the Related Art

Computer-based information processing is extensively used in a variety of fields. In general, the details of image processing are specified by software installed in the computer. Modification of the details of image processing requires updating of the software and is thus time-, labor-, and resource-consuming.

One example of the computer-based information processing is an image processing system of forms used in financial facilities. The image processing system scans a regular form, such as a transfer form, to obtain image data, makes the image data subjected to OCR to extract required data including the name and the amount of money, and uses the extracted data for a corresponding transaction. The image processing system gives a display of the extracted data and the image data in a comparative way and enables the operator to modify the data according to the requirements. There are a large variety of transfer forms used in the financial facilities, so that the required processing of data obtained from such transfer forms is also widely diversified in the financial facilities. The image processing system accordingly adopts a diversity of similar but slightly different software programs according to the types of transfer forms and the financial facilities.

Several techniques have been proposed to handle such diversity of processing. The first technique constructs the software with margins of customization. Construction of the multifunctional software taking into account the expected diversity including the large variety of transfer forms and the diversified processing allows for diverse series of processing by specifying the functions to be currently activated with parameters.

The second technique is an object-oriented programming technique. The software constructed by this technique specifies a general flow of processing as a combination of multiple modules, which respectively carry out relatively simple functions. The advantage of this technique is relatively easy addition of new modules and replacement of existing modules. Such addition and replacement of modules allows for the diverse series of processing.

The third technique is a Web programming technique frequently used in the Internet. HTML (Hyper Text Markup Language) files and scripts are transmitted from a server on the Internet to a client, and the client carries out diverse series of processing based on the transmitted HTML files and scripts. For example, a client with a browser mounted thereon actualizes a diversity of windows by simply modifying the HTML files without any significant change of the software.

These proposed techniques are, however, insufficient for customization required in the information processing apparatus. The first technique can not sufficiently deal with customization required over the expected range at the time of software construction. The second technique requires creation of new modules corresponding to additional functions and modification of the main program to call the newly added modules. This results in a significant change of the software. The third technique can not provide sufficient information processing functions, since the functions available by HTML are rather limited. The recent development of the technique XML (extensible Markup Language) expands the available functions to some extent, but still does not provide sufficient information processing functions.

The drawbacks discussed above are not restricted to the image processing system but are common to various information processing apparatuses. These problems are also common to the information processing apparatuses that actualize all the functions required for information processing by the software configuration as well as the information processing apparatuses that provide part of the functions as the hardware structure. These problems are especially significant in a system including multiple information processing apparatuses that are connected to one another via a network and cooperate with one another for information processing, since the multiple apparatuses individually require updating and customization.

### SUMMARY OF THE INVENTION

The object of the invention is thus to provide an information processing apparatus that ensures relatively easy customization, updating, and modification of the functions without any significant change of the software or circuit structure.

In order to attain at least part of the above and the other related objects, the present invention is directed to an information processing apparatus having a first structure discussed below. The information processing apparatus has multiple basic function modules that actualize preset basic functions. These basic function modules are constructed as individual elements and may be actualized by software or by hardware, for example, in the form of electronic circuits. The arrangement of the individual elements allows for relatively easy addition of new modules and replacement of existing modules.

In the information processing apparatus of the invention, specification of the processing is defined by an electronic document. The electronic document specifies basic function modules to be used for processing, among the multiple basic function modules. The information processing apparatus inputs this electronic document, analyzes the electronic document, and carries out the processing based on the analyzed electronic document. The basic function modules specified by the electronic document are sequentially activated to carry out the processing.

The information processing apparatus of the invention has the multi-purpose function of calling the required basic function modules according to the specification of the electronic document, in order to attain diverse series of processing. The substantial specification of the processing carried out by a combination of the basic function modules is defined in the electronic document. This arrangement ensures addition, modification, and customization of information processing functions by simply changing the contents of an externally given electronic document without any significant change of the software configuration or the hardware structure of the information processing apparatus.

In the information processing apparatus of the invention, combination of the basic function modules with the electronic document achieves diverse functions discussed below.

In a first preferable application of the invention, the multiple basic function modules include a window generation module that generates a window to be displayed on the information processing apparatus. The electronic document defines a specification and a generation timing of the window. The information processing apparatus activates the window generation module at the defined generation timing to generate the window. This arrangement enables an interface window or any other required window to be displayed at an arbitrary timing in the information processing apparatus.

In a second preferable application of the invention, the electronic document includes flow control information to determine an order of execution of multiple series of processing. The information processing apparatus activates the basic function modules in the order of execution according to the flow control information. The arrangement of this application is used for processing of a complicated flow, such as a loop or conditional branching. The flow control information is to be interpreted by the information processing apparatus and to be incorporated in the electronic document.

In a third preferable application of the invention, the multiple basic function modules include a plurality of element display modules. The element display modules respectively represent display elements, such as lines, buttons, and texts, which constitute the window. The electronic document defines a class and a position of each of the display elements constituting the window. The information processing apparatus activates the respective element display modules based on the electronic document, so as to generate the window defined by the electronic document. Diverse windows are generated relatively easily by simple modification of the contents of the electronic document.

The arrangement of the third application may be combined with the arrangement of the first application. Namely the window generation module of the first application may exert the function of reading the electronic document and activating the respective element display modules in the third application. Such combination ensures generation of diverse windows while freely regulating the generation timing of each window and the transition of windows.

In a fourth preferable application of the invention, the multiple basic function modules include a plurality of element operation modules. The element operation modules carry out predetermined operations, such as four arithmetic operations, with regard to data input into the information processing apparatus. The electronic document defines an operation of the data. The information processing apparatus activates the respective element operation modules based on the electronic document, so as to carry out the operation of the data. Diverse operations are carried out relatively easily by simple modification of the contents of the electronic document.

The information processing apparatus of the invention may have a second structure discussed below, in order to attain at least part of the above and the other related objects mentioned previously. Like the first structure, the second structure has multiple basic function modules. In the second structure, each basic function module is activated in response to a change in status of an object, which has been mapped to the basic function module in advance. The information processing apparatus of the second structure manages these objects and the mapping of these objects to the respective basic function modules. In response to a status change of the object, the information processing apparatus notifies the basic function module mapped to the object of the status change.

This arrangement enables the activation of the respective basic function modules to be synchronized relatively easily, and ensures addition of new basic function modules and replacement of existing basic function modules without any significant change of the software or the hardware of the information processing apparatus. The use of objects mapped to the basic function modules ensures normal operations of the basic function modules added or replaced.

For chain activation of a plurality of basic function modules, it is preferable that each of the basic function modules has the function of reflecting the result of activation on a certain object. In one example, a first basic function module and a second basic function module are sequentially activated in this order. The first basic function module is activated by a first object, and the second basic function module is activated by a second object. The first basic function module has the function of reflecting the result of activation on the second object. Activation of the first basic function module then easily triggers activation of the second basic function module.

In the information processing apparatus of the second structure, where the multiple basic function modules include a plurality of element display modules, a preferable application manages objects common to multiple windows separately from objects relating to a currently displayed window. The latter objects may be omitted from the object of management after a change of the current window to another window. The former objects are, however, to be stored regardless of the change of the window. Separate management of these objects ensures smooth control of the screen display.

In one preferable application of the information processing apparatus having the second structure, each basic function module registers the mapping to an object. The mapping of the basic function modules to the objects is dynamically registered according to the activation status and the possibility of activation of the basic function modules. This arrangement desirably relives the loading of management of the mapping required for normal operations of the basic function modules.

In the information processing apparatus of the second structure, one preferable application creates, in response to activation of each basic function module, an object mapped to the basic function module, while eliminating an object that is not mapped to any activated basic function module. This arrangement enables the objects to be dynamically created and eliminated according to the activation status of the basic function modules. This ensures management of objects while effectively utilizing resources like memory resources.

The information processing apparatus of the invention may have a third structure discussed below, in order to attain at least part of the above and the other related objects mentioned previously. The information processing apparatus of the third structure is connected to a network and carries out a predetermined series of processing based on information transmitted via the network. The information processing apparatus of the third structure stores data to be included in an electronic message transmitted via the network and a definition document that defines a format of the data, analyzes the definition document, and creates or decodes the electronic message based on the analyzed definition document. Creation of the substantial specification of the electronic message is defined by the definition document. The information processing apparatus is thus required to have the multi-purpose function of creating the electronic message according to the definition document. The arrangement of the third structure enables diverse electronic messages to be created and decoded relatively easily by simply modifying the definition document.

In one preferable application, the information processing apparatus of the third structure has a data management module that comprehensively manages multiple data relating to the predetermined series of processing. The information processing apparatus fetches the data to be included in the transmitted electronic message from the data management module, or notifies the data management module of the data extracted from the received electronic message. This arrangement ensures smooth transmission of data between the information processing apparatus and outside via the electronic message.

The third structure may use one or multiple definition documents. In the case of using the multiple definition documents, the electronic document may specify one or more definition documents to be used. This arrangement ensures selective use of the multiple definition documents. It is not required that the electronic document is one-to-one mapped to the definition document. For example, the electronic document may use different definition documents according to the result of conditional branching.

The first through the third structures discussed above may be applied individually or in combination to the information processing apparatus. The first structure and the second structure may be applied to a standalone information processing apparatus or an information processing apparatus connected to a network.

The specification of the processing executed by the information processing apparatus of the present invention may be set arbitrarily. One favorable example to which the principle of the present invention is effectively applied is image processing. Namely the present invention is also directed to an image processing apparatus that carries out a preset series of image processing, based on image data of a form.

The image processing apparatus has multiple basic function modules that actualize preset basic functions with regard to the preset series of image processing. The electronic document defines the specification of the image processing in a format of identifying basic function modules to be used for the image processing. The image processing apparatus analyzes the electronic document and sequentially activates the basic function modules identified by the analyzed electronic document, so as to implement the image processing. There are a large variety of forms used in the financial facilities and diverse series of related processing. Application of the principle of the present invention desirably relives the load required for customization of the image processing apparatus in each financial organization.

In one preferable application of the image processing apparatus of the invention, the multiple basic function modules include a data extraction module that extracts either of character data and numerical data from the image data. The electronic document specifies an area for the extraction from the image data and attribute of the extracted data. The image processing apparatus accordingly obtains data defined by the electronic document. This arrangement ensures relatively easy acquisition of data with regard to a wide variety of forms.

In another preferable application of the image processing apparatus of the invention, the multiple basic function modules include an image display module, a data display module, and a data modification module. The image display module displays the image data. The data display module displays either of character data and numerical data extracted from the image data. The data modification module modifies either of the character data and the numerical data. The electronic document specifies a display form of the image data and either of the character data and the numerical data, as well as a method of modifying either of the character data and the numerical data based on an external input. The image processing apparatus accordingly carries out display of the image, characters, and numerical values and modification of the data, based on the specification of the electronic document. This arrangement ensures relatively easy modification of data with regard to a wide variety of forms.

The above description shows only the typical structures of the image processing apparatus. Any of the various arrangements of the information processing apparatus discussed above is also applicable to the image processing apparatus.

In the information processing apparatus and the image processing apparatus of the present invention, the electronic document may be in any of diverse formats. One preferable example is a document described in XML (hereafter referred to as the XML document). The XML document represents a document described in a markup language including tags. The tags may be set arbitrarily. The use of XML enables various commands required for the electronic document to be relatively easily defined in the form of tags.

The present invention is not restricted to the information processing apparatus or the image processing apparatus discussed above, but may be actualized in diverse applications. The possible applications include an information processing method and an image processing method corresponding to the information processing apparatus and the image processing apparatus discussed above, as well as computer programs that cause the computer to execute the corresponding series of processing. When the present invention is applied to a computer program, it is preferable that the computer program is executable on a browser. JAVA (registered trademark) is one of preferable techniques for the purpose. This arrangement enables the computer program to be executable regardless of the platform and easily utilize XML documents as electronic documents.

Another application is a storage medium in which any of the diverse computer programs is stored. Typical examples of the storage medium include flexible disks, CD-ROMs, DVDs, magneto-optic discs, IC cards, IC chips, ROM cartridges, punched cards, prints with barcodes or other codes printed thereon, internal storage devices (memories like a RAM and a ROM) and external storage devices of the computer, and a variety of other computer readable media in any of optical, magnetic, and electrical manners.

The above and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates the system construction of an information processing apparatus in one embodiment of the present invention;

FIG. 2 shows the outline of a flow definition;

FIG. 3 shows an example of cursor control commands;

FIG. 4 shows the outline of a screen definition;

FIG. 5 shows linkage of parts;

FIG. 6 shows a process of creating and decoding an electronic message;

FIG. 7 shows modules included in an execution engine;

FIG. 8 shows modules included in an application browser;

FIG. 9 shows modules included in a message bus;

FIG. 10 is a flowchart showing an activation process;

FIG. 11 schematically shows the structure of screen after activation;

FIG. 12 is a flowchart showing a series of processing executed by the execution engine;

FIG. 13 is a flowchart showing a screen manipulation process;

FIG. 14 schematically illustrates the construction of an image processing system in a second embodiment of the invention;

FIG. 15 shows the software configuration of an image work flow system; and

FIG. 16 is a flowchart showing general image processing.

### DESCRIPTION OF THE PREFERRED EMBODIMENTS

Some modes of carrying out the invention are discussed below as preferred embodiments in the following sequence:

A. First Embodiment

A-1. System Construction

A-2. Flow Definition

A-3. Screen Definition

A-4. Linkage of Parts

A-5. Transmission of Electronic Message

A-6. Execution Engine

A-7. Application Browser

A-8. Message Bus

A-10. Activation Processing

A-11. Command Processing of Flow Definition

A-12. Screen Manipulation Processing

B. Second Embodiment (Image Processing System)

B-1. System Construction

B-2. Software Configuration

B-3. Image Processing

C. Modifications

A. First Embodiment

A-1. System Construction

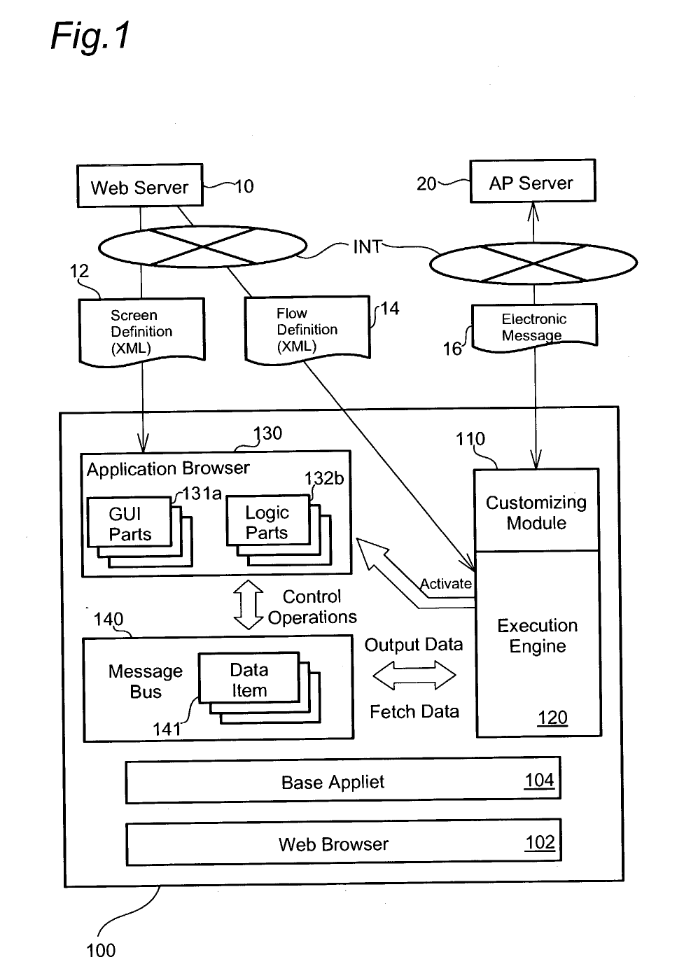

FIG. 1 illustrates the system construction of an information processing apparatus 100 in one embodiment of the present invention. The information processing apparatus 100 is constructed by installing software, which includes respective functional blocks shown in FIG. 1, in a general-purpose computer. These functional blocks may be provided as hardware components, instead of the installed software.

The information processing apparatus 100 is connected to a Web server 10 and an AP server 20 via a network INT. The network may be a wide area network like the Internet or a relatively restrictive network like a LAN (local area network).

The Web server 10 transmits electronic documents called a screen definition 12 and a flow definition 14 in response to a request from the information processing apparatus 100. The screen definition 12 is an electronic document that defines the specification of a window. The flow definition 14 is an electronic document that defines the flow of processing, such as transition of windows. The details of these electronic documents will be discussed later. The electronic documents are described in XML in this embodiment, although any of diverse formats is applicable.

The AP server 20, in cooperation with the information processing apparatus 100, executes diverse series of processing. For example, in a system where a host computer receives input data from a terminal and executes diverse series of processing, the terminal corresponds to the information processing apparatus 100 and the host computer corresponds to the AP server 20. Information is transmitted between the information processing apparatus 100 and the AP server 20 in the form of an electronic message 16. The method of generating the electronic message 16 will be discussed later. The electronic message 16 is described in XML in this embodiment, although any of diverse formats is applicable.

In the system construction of this embodiment, the information processing apparatus 100 is connected with the Web server 10 and the AP server 20 via the network, though the information processing apparatus 100 may be constructed as a standalone type. The Web server 10 and the AP server 20 may not be used, while the information processing apparatus 100 may work in a standalone manner according to the specification of information processing to be executed.

The following describes the details of the respective functional blocks included in the information processing apparatus 100. A Web browser 102 actualized as software is installed in the information processing apparatus 100 to be run on a predetermined operating system and is used to browse files described in a markup language, such as HTML. The respective functional blocks are arranged to work on this Web browser 102. In this embodiment, JAVA (trademark) is used to actualize this arrangement. The arrangement of making the functional blocks work on the Web browser 102 advantageously allows for the software configuration independent of the platform. The functional blocks may alternatively be arranged to work independently of the Web browser 102.

A base applet 104 is run on the Web browser 102 and provides a platform for operating the respective functional blocks of the information processing apparatus 100, that is, an execution engine 120, an application browser 130, and a message bus 140. The whole mechanism that attains information processing by the base applet 104 and the respective functional blocks is referred to as the XML application program in the specification hereof. In this embodiment, this mechanism is constructed on the XML base. The XML application program, however, represents the concept of the mechanism discussed below in the wide sense, and is thus not restricted to the construction on the XML base.

The base applet 104 is structured as a JAVA applet. The base applet 104 has functions of activating and terminating the respective functional blocks established thereon and functions of transferring operation results of a keyboard, a mouse, and the like of the computer (hereafter referred to as ‘key events’) to the respective functional blocks of the XML application program.

The execution engine 120 functions to control the general flow of processing, based on the specification of the flow definition 14. The application browser 130 is activated accordingly when the flow definition 14 defines display and transition of windows. The electronic message 16 is transmitted in the case of definition of data transmission to and from the AP server 20. The contents of the electronic message 16 depend upon the AP server 20 and are thus adjusted by a customizing module 110. The execution engine 120 outputs data, which have been received from the AP server 20, to the message bus 140 and fetches data, which are to be transmitted to the AP server 20, from the message bus 140.

The application browser 130 is activated by the execution engine 120 to display a window according to the screen definition 12 and allow for operations on the window. The application browser 130 is a different program from the Web browser 102. The application browser 130 includes multiple GUI parts 131a and multiple logic parts 132b to carry out basic functions. The GUI parts 131a are software packages for generating display elements constituting a window, for example, buttons and lines. The multiple GUI parts 131a are provided corresponding to the respective classes of display elements. The logic parts 132b are software packages for executing data processing on the window, for example, four arithmetic operations and check of input condition. The multiple logic parts 132b are provided corresponding to the classes of the processing. The application browser 130 activates these parts according to the screen definition 12 to carry out the diverse processing relating to the window to be displayed.

The message bus 140 functions to control operations of the GUI parts 131a and the logic parts 132b. The message bus 140 includes multiple data items 141 corresponding to the multiple GUI parts 131a and the logic parts 132b. Each part is designed to be triggered by a change in status of the corresponding data item 141 and to make the result of the processing reflected on the corresponding data item 141. In response to a change in status of a data item 141 under management, the message data bus 140 notifies the corresponding part of the status change and thereby activates the corresponding part. The message bus 140 also functions to hold data required for the processing. As mentioned previously, the data transmitted between the execution engine 120 and the AP server 20 are managed as the data items 141 by the message bus 140.

The information processing apparatus 100 of the above construction carries out diverse series of processing. The execution engine 120, the application browser 130, and the message bus 140 are the software that does not depend upon the specification of the processing but allows for multi-purpose functions. The software dependent on the specification of the processing is provided in the form of modules like the GUI parts 131a and the logic parts 132b. The substantial specification of the processing is determined, for example, in a format of defining the order of using these parts in the electronic documents including the flow definition 14 and the screen definition 12. The information processing apparatus 100 advantageously ensures easy modification of the processing specification by simply changing the contents of the electronic documents, without significantly modifying or adding the software. The respective constituents shown in FIG. 1 are discussed below in detail.

A-2. Flow Definition

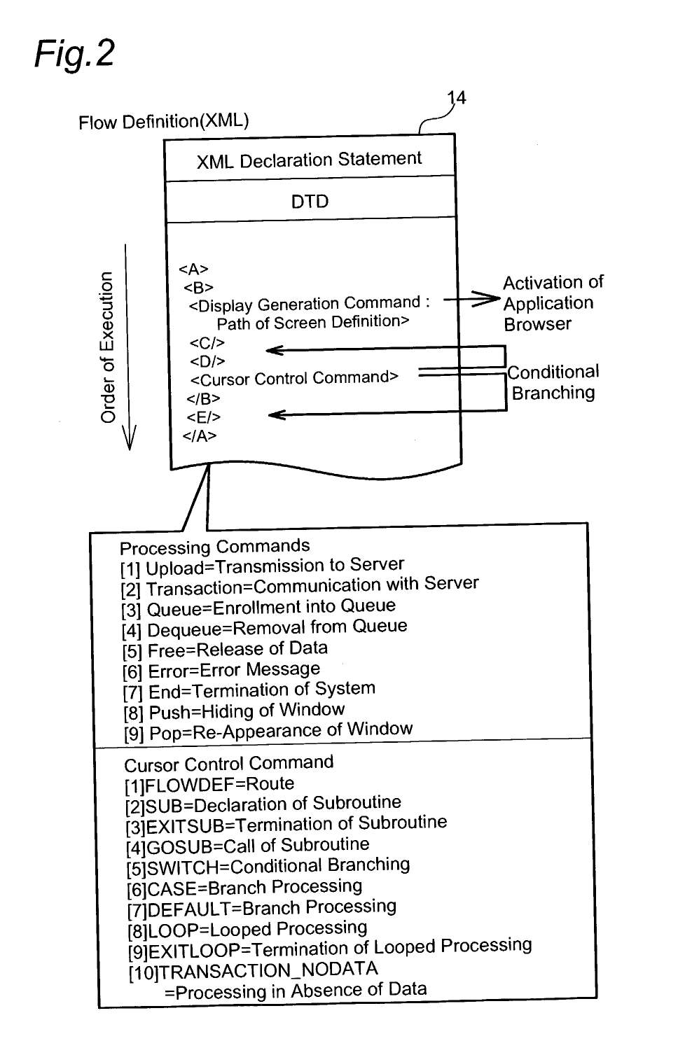

FIG. 2 shows the outline of the flow definition 14. The flow definition 14 is an electronic document that defines the operations of the execution engine 120 and is described in XML in this embodiment.

The flow definition 14 includes an XML declaration statement, a DTD (document type definition) and a text. The DTD defines tags used in the flow definition. Only the DTD may be provided as a separate document from the flow definition.

The text includes multiple tags that define the specification of the processing to be executed by the execution engine 120. The execution engine 120 typically interprets the tags included in the text of the flow definition 14 from the top and executes commands defined by the respective tags. For example, when a display generation command is read from the flow definition 14, the execution engine 120 activates the application browser 130 to display a window. The screen definition 12 is required for displaying the window (see FIG. 1). The display generation command accordingly specifies the path of the screen definition 12 to be referred to by the application browser 130.

The lower half of the drawing shows an example of commands defined by the tags. The commands are broadly classified into two groups, a group of processing commands and a group of cursor control commands. The processing commands define the specification of the processing practically executed by the execution engine 120. For example, the processing commands include commands of upload to and transaction with the AP server 20, queue and dequeue commands, and push and pop commands of the window. The push and pop commands of the window are included in the display generation commands. The details of each command will be discussed later, in combination with the functions of the execution engine 120.

The cursor control commands define interpretation of tags and the order of execution of the tags in the flow definition. As described above, in principle, the execution engine 120 sequentially executes the tags from the top. The cursor represents a target tag, which is currently processed by the execution engine 120. The cursor control commands function to shift the position of the cursor against this principle. As shown in the upper half of the drawing, for example, a cursor control command included in the flow definition 14 allows for conditional branching to change over the target tag of the processing to a tag D or a tag E.

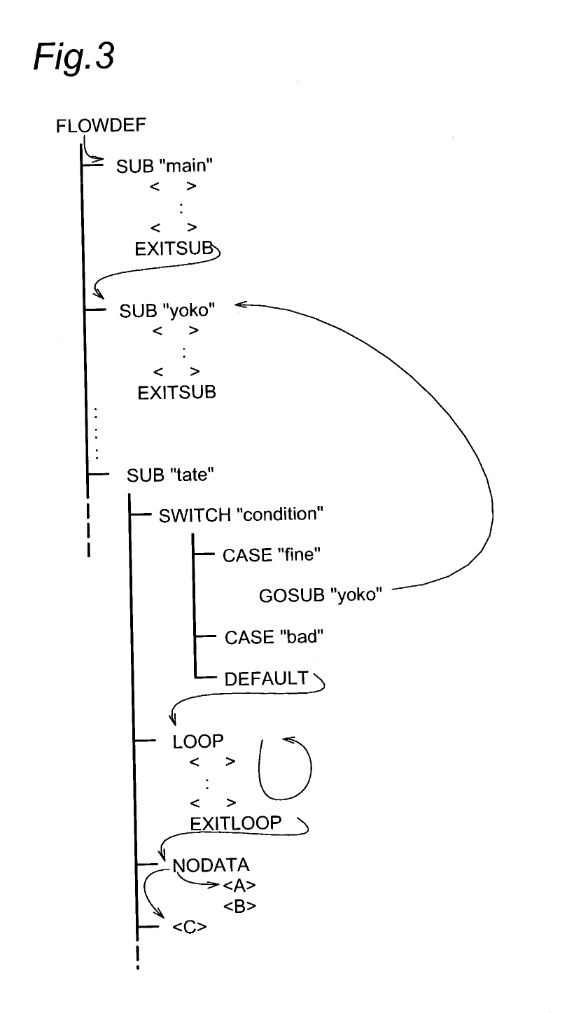

This embodiment provides ten cursor control commands shown in FIG. 2. FIG. 3 shows an example of the cursor control commands. In general, XML tags hold a tree structure. The flow definition 14 may thus be expressed by a tree structure as shown in FIG. 3.

A cursor control command ‘FLOWDEF’ defines a route of the flow definition. The execution engine 120 shifts the cursor to a sub-routine “main”, in response to this command ‘FLOWDEF’.

A command ‘SUB’ represents declaration of a specified sub-routine. In the example of FIG. 3, three sub-routines “main”, “yoko”, and “tate” are provided. A command ‘EXITSUB’ represents termination of the specified sub-routine. The execution engine 120 exits from the specified sub-routine and shifts the cursor to a next tag, in response to this command.

A command ‘GOSUB’ represents call of the specified sub-routine. In response to a tag ‘GOSUB “yoko”, the execution engine 120 shifts the cursor to the subroutine “yoko”.

A command ‘SWITCH’ represents conditional branching. A command ‘CASE’ shows the destination of the cursor according to a specified condition. A command ‘DEFAULT’ represents a series of default processing. In the example of FIG. 3, the command ‘SWITCH’ actualizes the conditional branching according to the status of an object “condition”. When the object “condition” is in the status of “fine”, a series of processing under a tag ‘CASE’ “fine” is carried out. When the object “condition” is in the status of “bad”, on the other hand, a series of processing under a tag ‘CASE’ “bad” is carried out. When the object “condition” is in neither of these statuses, a series of processing under the tag ‘DEFAULT’ is carried out.

A command ‘LOOP’ represents execution of a certain loop of processing. A command ‘EXITLOOP’ represents termination of the certain loop of processing. The execution engine 120 repeatedly executes a series of processing between the command ‘LOOP’ and the command ‘EXITLOOP’.

A command ‘NODATA’ changes over the specification of the processing according to the presence or the absence of data referred to. In the example of FIG. 3, in the absence of data referred to, a series of processing defined by tags A and B is executed. In the presence of data referred to, on the other hand, a series of processing defined by a tag C is executed.

Inclusion of the cursor control commands in the flow definition 14 allows for description of complicated processing, such as conditional branching and looped processing. The commands shown in FIGS. 2 and 3 are only illustrative, and the number of and the types of the commands are not at all restricted to this example.

A3. Screen Definition

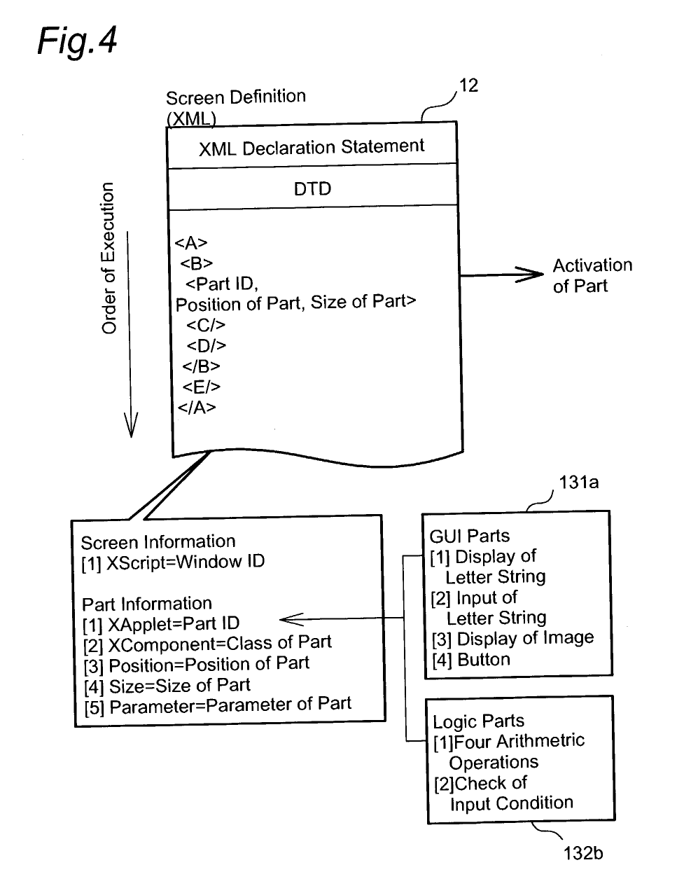

FIG. 4 shows the outline of the screen definition 12. The screen definition 12 is an electronic document that defines the operations of the application browser 130 and is described in XML in this embodiment.

The text in the screen definition 12 includes multiple tags that define the layout of a window and the details of the operations carried out on the window. The tags are broadly classified into two groups, that is, a group of screen information and a group of parts information. The screen information includes a tag that allocates a window ID to each window defined by the screen definition 12. The screen definition 12 is provided corresponding to each window used in the information processing apparatus 100. The window ID is a piece of information for identifying each window.

The parts information defines various pieces of information required for activation of the GUI parts 131a and the logic parts 132b. The GUI parts 131a include various software packages for generating the display elements on the window, such as display of letter string, input of letter string, display of image, and button. The logic parts 132b include various software packages relating to operations on the window, such as four arithmetic operations and check of input condition. In the description below, in order to avoid confusion, unless otherwise specified, the software packages provided as the GUI part 131a or the logic part 132b are referred to as ‘parts’, and the individual display elements and other objects generated by the ‘parts’ are referred to as ‘part objects’.

The parts information includes tags that specify a part ID allocated to each of the GUI parts 131a and the logic parts 132b, as well as the class, the position, the size, and the parameter of the part. The window may include multiple part objects generated by an identical part. For example, multiple buttons as part objects may be generated by a single GUI part 131a ‘button’. The part IDs are identification information for individually managing the multiple part objects generated by the parts. The position and the size of the part may be set, for example, in a coordinate system defined on the screen. The parameter of the part is, for example, the shape of a button, the color, or the font of letters.

The application browser 130 sequentially reads the tags in the screen definition from the top and executes series of processing according to the respective tags. The application browser 130 reads the tags for specifying the part ID and the position and the size of each specified part and executes the processing to activate the specified part according to the tags. Part objects corresponding to the respective activated parts are displayed on the window to allow for operations on the window. The tags, the GUI parts 131a, and the logic parts 132b shown in FIG. 4 are only illustrative, and the numbers and the types of the tags and the parts are not at all restricted to this example.

A-4. Linkage of Parts

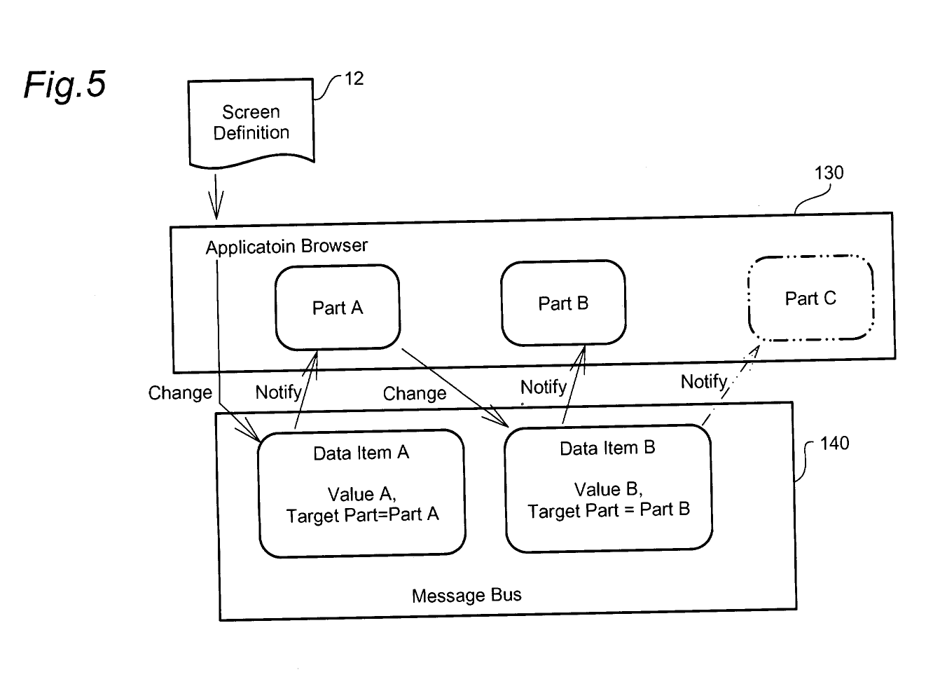

FIG. 5 shows linkage of parts. In the structure of the embodiment, the application browser 130 activates the respective parts via the message bus 140.

The message bus 140 performs total management of data items. Each data item has an intrinsic value and is mapped to one or multiple parts used in the application browser 130. The mapping is registered for each data item. In the illustrated example, a data item A has an intrinsic value A and is mapped to a part A. A data item B has an intrinsic value B and is mapped to a part B. In the occurrence of a change in value of a certain data item, the message bus 140 functions to notify the part mapped to the certain data item of the change. In the structure of this embodiment, this function of the message bus 140 allows respective parts to be activated manually in the following manner.

In one example, it is assumed that a tag in the screen definition 12 defines activation of the part A. The application browser 130 reads this tag and changes the value A of the data item A to a specified value as an activation trigger of the part A. The message bus 140 notifies the part A mapped to the data item A of this change. The part A is activated in response to the notification. In this example, the part A has been programmed to change the value of the data item B after the activation. Activation of the part A thus triggers a change in value B of the data item B. The message bus 140 notifies the part B mapped to the data item B of this change. The part B is activated in response to the notification.

Such use of the data items under management of the message bus 140 facilitates linkage of multiple parts. For example, in response to a press of a button, the display of a letter string may readily be changed in conjunction with a change in display of the button.

Activation of the respective parts via the data items facilitates addition of new parts and replacement of existing parts. In one example, it is assumed that a new part C, which is activated in conjunction with the part A, is to be added. In this case, the required process provides a software package for the part C in the application browser 130 and adds the part C as another target part of the data item B. Activation of the part A triggers a change in value of the data item B. The message bus 140 notifies both the parts B and C of the change, so as to activate these parts B and C. In this manner, addition of a new part linked with the part A is easily attained without modifying the contents of the part A.

This embodiment applies the procedure shown in FIG. 5 to activate multiple parts and attain flexible linkage of these parts. A modified procedure may cause the part A, for example, to directly activate the parts B and C.

A-5. Transmission of Electronic Message

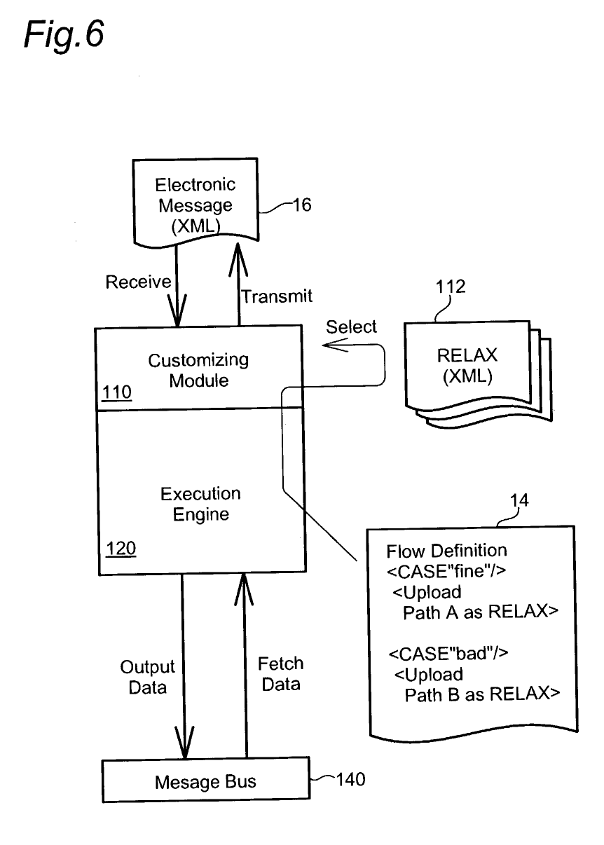

FIG. 6 shows a process of creating and decoding an electronic message. The execution engine 120 transmits data to and from the AP server 20 via the electronic message 16. The electronic message 16 is required to have a format according to the class of data and the contents of an application program provided by the AP server 20. The execution engine 120 readily creates electronic messages 16 of diverse formats according to the process shown in FIG. 6.

The execution engine 120 reads a RELAX 112, which is an electronic document for specifying a desired format, at the time of receiving or transmitting the electronic message 16. The RELAX document 112 may have any of diverse forms and is described in XML in this embodiment. The electronic message 16 to be received and transmitted adopts multiple formats, so that a plurality of the RELAX documents 112 are provided. The RELAX documents 112 may be stored in advance in the information processing apparatus 100 or may be supplied from, for example, the Web server 10.

At the time of execution of processing accompanied by data transmission, selection of a desired RELAX 112 is specified in the flow definition 14. One example is shown in FIG. 6. When the condition for conditional branching is “fine”, a path A is specified as the desired RELAX 112. When the condition for conditional branching is “bad” , on the other hand, a path B is specified as the desired RELAX 112. In response to transfer of the path name from the execution engine 120 to the customizing module 110, the customizing module 110 selects the RELAX 112 corresponding to the path name and creates the electronic message 16 for transmission or decodes the received electronic message 16 based on the selected RELAX 112. The execution engine 120 transmits data to and from the message bus 140 accompanied with the transmission or reception of the electronic message 16.

The execution engine 120 does not have the creating function dependent upon each electronic message 16 but has the multi-purpose function of creating the electronic message 16 based on the RELAX 112. This multi-purpose function of the execution engine 120 allows for creation of diverse electronic messages 16 without modifying the execution engine 120.

A-6. Execution Engine

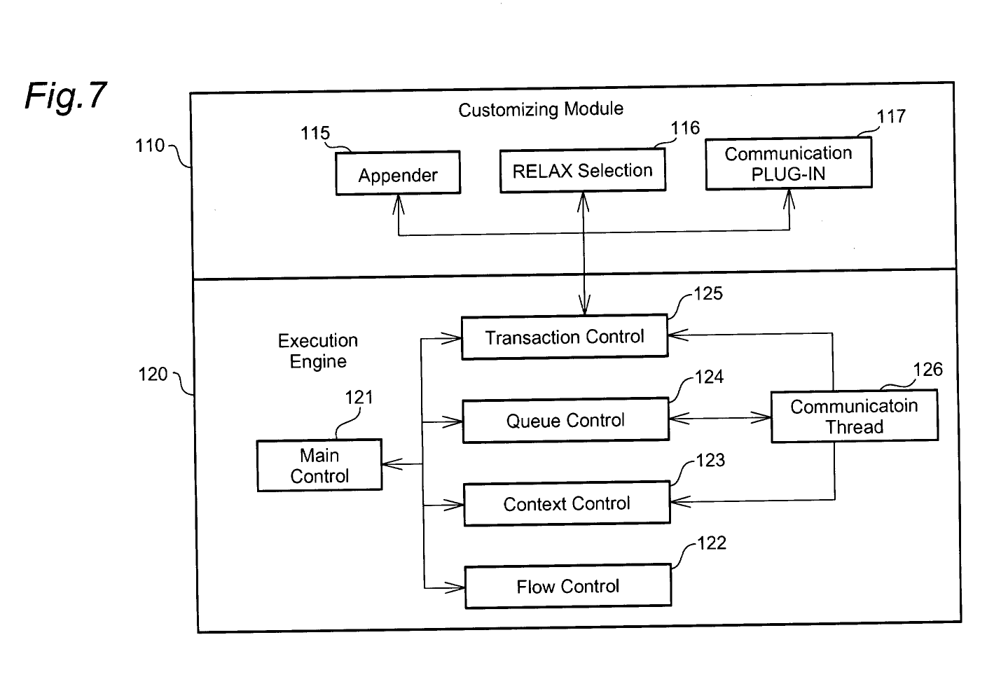

FIG. 7 shows modules included in the execution engine 120. The execution engine 120 has multiple functional blocks constructed by software. The respective functional blocks work under control of a main control 121.

A flow control 122 functions to read the flow definition and control processing according to the contents of the flow definition. As discussed previously with reference to FIG. 2, the flow definition includes processing commands and cursor control commands. The flow control 122 interprets each cursor control command and implements a shift of the cursor according to the cursor control command. The main control 121 interprets each processing command and activates the functional block in response to the processing command.

A context control 123 controls display of a window and is activated in response to the processing command ‘Push’ (hiding of a window) or ‘Pop’ (re-appearance of a window) (see FIG. 2). The context control 123 appropriately activates or stops the application browser 130 to implement the control with regard to display of the window.

A transaction control 125 carries out communication control with regard to transmission of the electronic message to and from the AP server 20. The transaction control 125 is activated in response to the processing command ‘Upload’ (transmission to server) or ‘Transaction’ (communication with server) (see FIG. 2). The electronic message is created, based on the RELAX in this embodiment. The transaction control 125 uses a RELAX selection 116, an appender 115, and a communication plug-in 117 to process the electronic message. The RELAX selection 116 functions to select the RELAX document to be applied for creation or interpretation of the electronic message. The appender 115 generates a header and other additional information with regard to data to be included in the electronic message, which is to be transmitted. The communication plug-in 117 transmits the electronic message to and from the AP server 20 according to a communication protocol. These functions require customization according to the functions of the AP server 20 and the class of the communication protocol. In the structure of this embodiment, these functions are thus included in the customizing module 110 and are provided separately from the multi-purpose functional blocks included in the execution engine 120.

A queue control 124 functions to synchronize the transaction control 125 and the context control 123. The queue control 124 is activated in response to the processing command ‘Queue’ (enrollment into queue) or ‘Dequeue’ (removal from queue) (see FIG. 2). The queue control 124 creates a communication thread 126, which is to be transferred to the transaction control 125, and stores the communication thread 126 into a queue. The transaction control 125 establishes communication with the AP server 20 at an appropriate timing, based on the queue. The communication thread 126 holds data received from the AP server 20 and activates the context control 123 at an appropriate timing to display a window according to the received data. The use of the queue enables prior communication with the AP server 20 and storage of the communication result and thus ensures a smooth transition of windows.

A-7. Application Browser

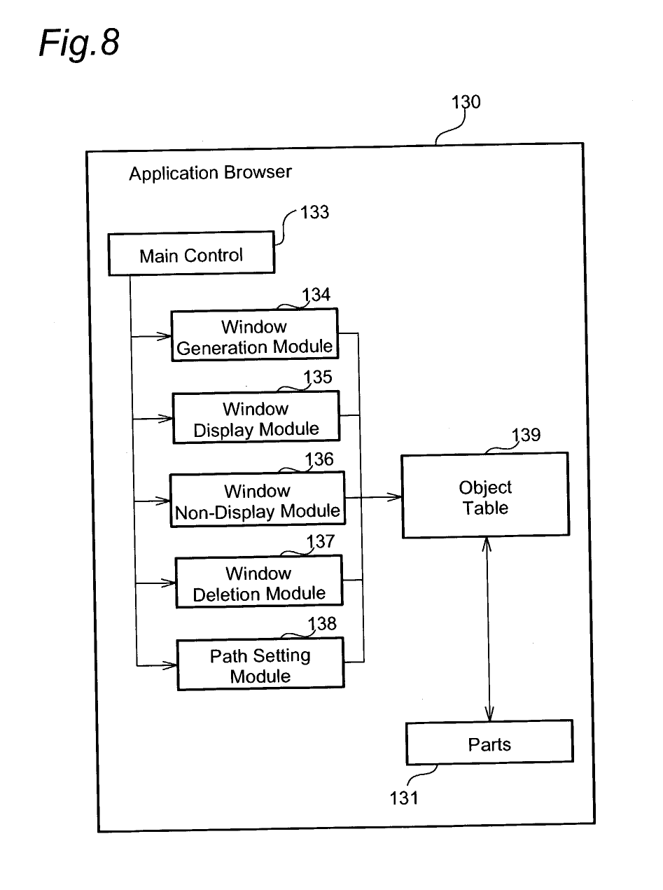

FIG. 8 shows modules included in the application browser 130. The application browser 130 has multiple functional blocks operated under control of a main control 133.

A window generation module 134 functions to generate part objects, which are constituents of each window, based on the specification of the screen definition. A window display module 135 sequentially displays the part objects thus generated to constitute the window, in response to an instruction from the main control 133. A window non-display module 136, on the contrary, hides the part objects to remove the window. A window deletion module 137 wastes the part objects to delete information with regard to the window. A path setting module 138 sets the name of a path for identifying each window, that is, a window ID.

The respective part objects used on the window are generated by parts 131 and are managed in an object table 139. The parts 131 include both the GUI parts 131a and the logic parts 132b discussed previously. The respective functions of the application browser 130 are implemented by registration of the part objects into the object table 139 and display and hiding of the part objects.

A-8. Message Bus

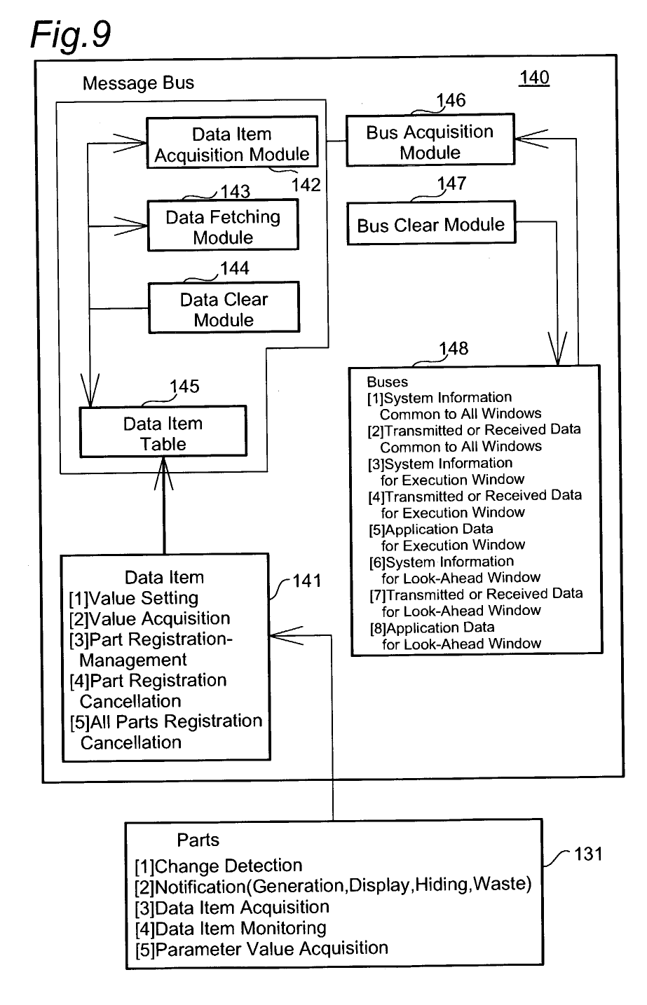

FIG. 9 shows modules included in the message bus 140. The message bus 140 has a function of consolidating the data items 141. In the structure of this embodiment, multiple buses 148 are built in the message bus 140. The respective buses 148 divisionally carry out the management according to the class of the data items 141. The buses 148 include stationary buses provided in advance, as well as dynamic buses generated according to the requirements.

A bus acquisition module 146 generates a bus 148. A bus clear module 147 eliminates a non-required bus. Eight classes of buses 148 are provided in this embodiment. One class of bus may include multiple buses. For example, each class of bus [6] through [8] with regard to a look-ahead window may include multiple buses according to the contents of the window.

Functional blocks for managing the data item 141 are provided corresponding to each of the buses 148. A data item acquisition module 142 acquires a value representing the status of a target data item, which is included in object of management. The data item acquisition module 142 also has a function of generating a data item. As described above, the data item is an object used to attain linkage of multiple parts. The system of the embodiment dynamically generates a data item according to the operating status of a part. The data item acquisition module 142 carries out retrieval and determines whether or not a data item required for operation of a certain part is included in the object of management. When not included, the data item acquisition module 142 generates the required data item and adds the generated data item to the object of management. This arrangement ensures effective use of the hardware resource for management of the data items.

A data fetching module 143 fetches data, which are to be included in the electronic message created by the execution engine 120, from the data item. A data clear module 144 clears data held in the data item. The data item, which is included in the object of management, is registered in a data item table 145. The functional blocks discussed above refer to this data item table 145 to implement the respective functions.

The functions of the data item 141 are enumerated in FIG. 9. The data item 141 has the following five functions. A value setting function sets an externally informed value to the value held in the data item 141 and, in the case of a change of the value, notifies one or multiple parts mapped to the data item 141 of the change. This corresponds to the function of attaining the linkage discussed previously with reference to FIG. 5. A value acquisition function answers the value held in the data item 141, in response to an external inquiry. A part registration-management function manages the parts, which are the objects of notification, in the case of a change of the value held in the data item 141. A part registration cancellation function individually cancels registration of a part, and an all parts registration cancellation function collectively cancels registration of all parts. These functions enable the data item 141 to control activation and linkage of the parts as discussed previously with reference to FIG. 5.

Each part 131 actively carries out registration into the data item 141 in the structure of the embodiment. The functions of the part 131 are also enumerated in FIG. 9.

The part 131 has the following five functions. A change detection function detects a change of the value held in the data item 141. This corresponds to the function of receiving the notification of the change from the data item 141. A notification function notifies outside of generation, display, hiding, and waste of a part object. A data item acquisition function retrieves the data item 141, to which the part 131 is mapped. A data item monitoring function carries out registration of the part 131 into the data item 141, to which the part 131 is mapped. A parameter value acquisition function acquires a parameter specified in the process of generating a part object.

In the structure of the embodiment, the part 131 takes charge of registration into the data item 141, to which the part 131 is mapped. In one modified application, the data item 141 may retrieve and register the part 131. In the structure of the embodiment, the data item 141 notifies the part 131 of a change of the value held in the data item 141. In one modified application, the part 131 continuously monitors the value held in the data item 141 and detects a change of the value.

The information processing apparatus 100 constructed as discussed above allows for flexible processing and generation and interpretation of electronic messages, based on the electronic documents, such as the flow definition, the screen definition, and the RELAX document. The specification of the processing is readily and flexibly changed by simply modifying these electronic documents, without changing the basic construction of the XML application program.

A-10. Activation Processing

The following describes a procedure of the respective steps to activate the XML application program and execute the processing according to the flow definition.

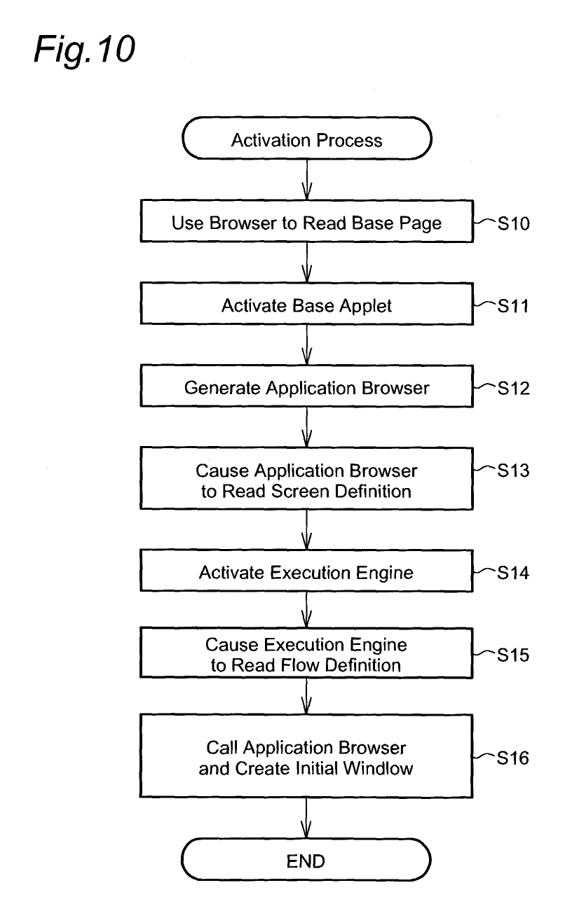

FIG. 10 is a flowchart showing an activation process. This process starts in the active state of the browser in the information processing apparatus 100, in response to an operator's input of a URL of an XML application program base page. The XML application program base page represents a Web page that provides the base applet 104 and is described in XML in this embodiment. The URL may specify a location inside the information processing apparatus or a location in the external Web server 10.

In response to input of the URL, the information processing apparatus 100 uses the browser to read the XML application program base page (step S10) and activate the base applet 104 provided by the XML application program base page (step S11). The base applet 104 is a software package to provide the platform, on which the XML application program runs, as discussed previously with reference to FIG. 1.

Owing to the functions of the base applet 104, the information processing apparatus 100 generates the application browser 130 (step S12). The application browser 130 generated here corresponds to the browser working as the platform for activating the XML application program. The application browser 130 reads an initial screen definition specified in advance by the base applet 104 (step S13). The window generated according to this initial screen definition is hereafter referred to as the ‘base window’. The application browser 130 activates the execution engine 120 on the base window (step S14). This attains the status that allows for operations of the XML application program.

The execution engine 120 reads the flow definition (step S15), and calls the application browser 130 based on the flow definition to generate an initial window (step S16). The URL of the flow definition to be read by the execution engine 120 has been set in advance. The URL may otherwise be given by the base applet 104 or the initial screen definition.

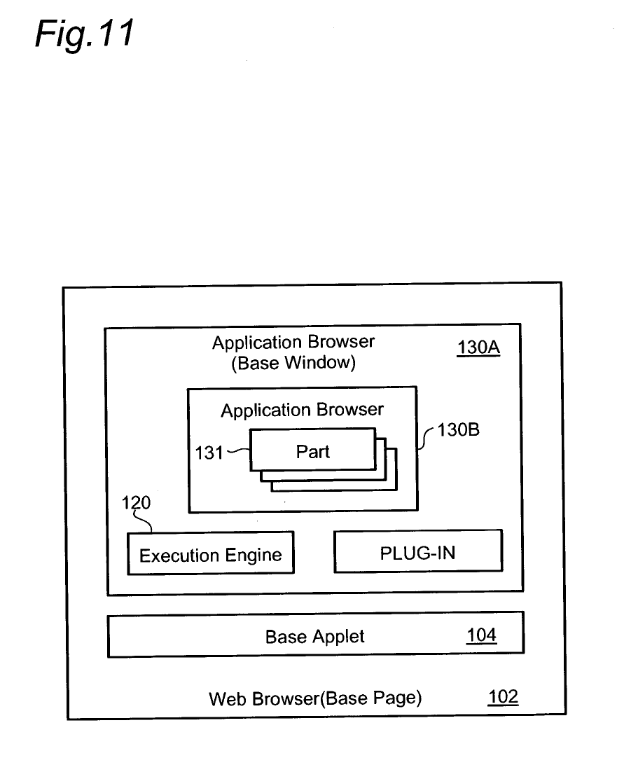

FIG. 11 schematically shows the structure of the screen after the activation. The XML application program runs on the Web browser 102 that has read the XML application program base page. The base applet 104 runs on the XML application program base page.

The base applet 104 generates an application browser 130A as the platform for the XML application program, and provides an XML application program base window. The execution engine 120 is activated on the XML application program base window. A plug-in for providing communication and other functions may also be activated according to the requirements. The execution engine 120 then activates an application browser 130B. The application browser 130B activates the diversity of parts 131 to create a window as discussed previously. The parts 131 include both the GUI parts 131a and the logic parts 132b. Activation of the application browser 130B is called in response to every instruction for display and transition of windows in the flow definition.

On completion of the activation of the XML application program according to the above procedure, the execution engine 120 starts substantial processing based on the flow definition.

A-11. Command Processing of Flow Definition

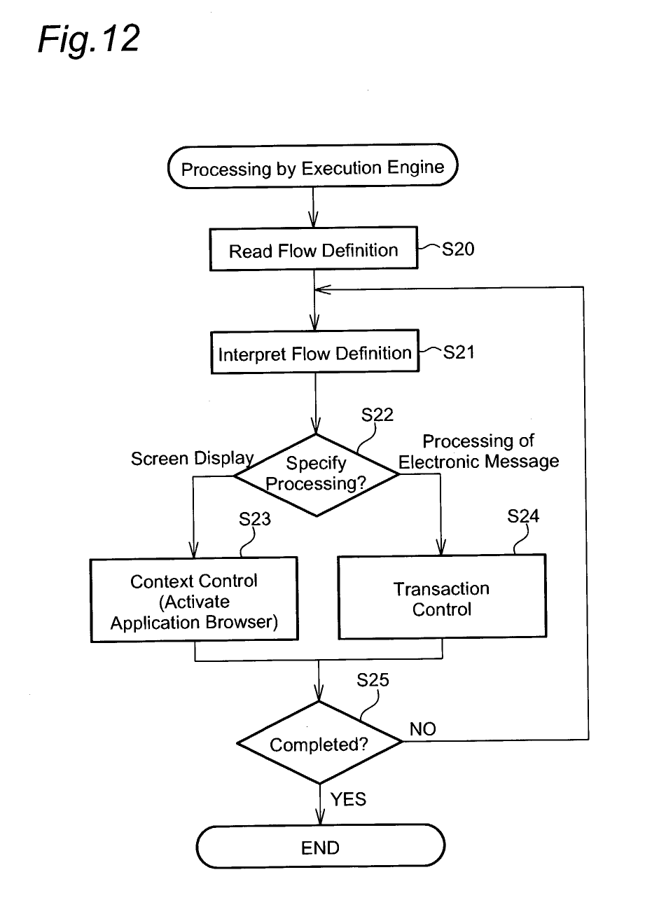

FIG. 12 is a flowchart showing a series of processing executed by the execution engine 120. The execution engine 120 reads the flow definition (step S20), interprets the tags included in the flow definition (step S21), and specifies the processing based on the tags of the flow definition (step S22).

When the flow definition specifies processing for screen display, the execution engine 120 carries out the context control (step S23). The context control activates the application browser 130 to generate a window and allow for operations on the screen. During activation of the application browser 130, the control of the information processing apparatus 100 has shifted to the application browser 130. At step S23, the execution engine 120 waits for completion of the series of processing executed by the application browser 130. When the flow definition specifies processing of the electronic message, the execution engine 120 carries out the transaction control (step S24). The transaction control refers to the RELAX document and creates or decodes the electronic message. The execution engine 120 may execute diverse series of other processing according to the contents of the tags, although not being specifically illustrated.

The execution engine 120 iteratively executes the above series of processing until the specification of the flow definition is completed (step S25).

A-12. Screen Manipulation Processing

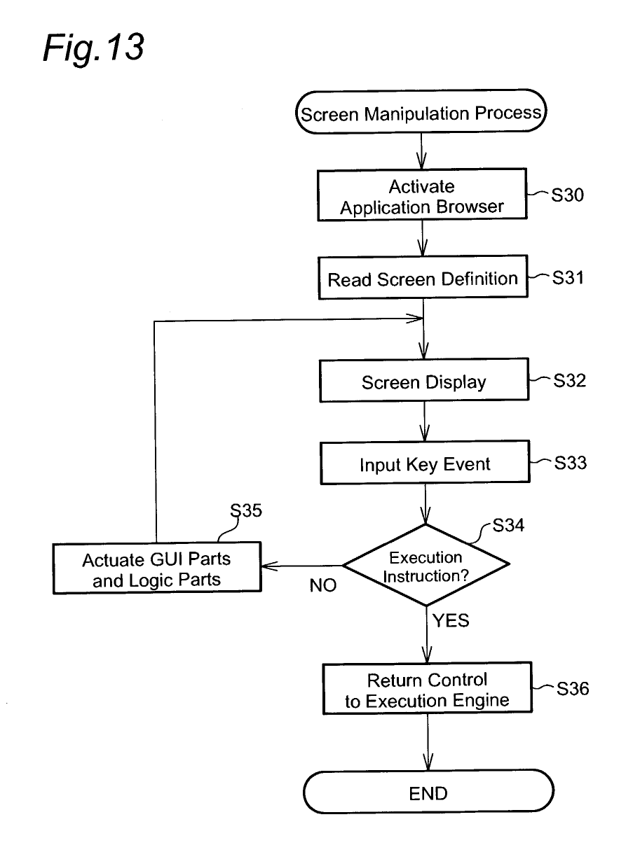

FIG. 13 is a flowchart showing a screen manipulation process. In response to a call from the execution engine 120, the application browser 130 is activated (step S30) to carry out manipulation of the screen, such as screen display.

The application browser 130 first reads the screen definition specified at the call (step S31) and implements the screen display according to the specification of the screen definition (step S32). The screen display is attained by calling the respective parts based on the specification of the screen display, as described previously.

In this state, the application browser 130 waits for input of a key event (step S33). The key event is a result of manipulation of the keyboard and the mouse in the information processing apparatus 100. The base applet 104 detects the manipulation of these input units and outputs a message representing the details of the manipulation to the message bus 140. The application browser 130 monitors the message bus 140 and detects the key event based on the output.

When the key event is an execution instruction with regard to transition of windows, communication with the AP server 20, deletion of a window, or termination of the XML application program, the application browser 130 concludes the required operation and returns the control to the execution engine 120 (step S36). In the case where the execution instruction requires removal of the screen display, such as the deletion of a window or the termination of the XML application program, the application browser 130 removes the current display on the screen and then returns the control to the execution engine 120. In the case where the execution instruction does not require removal of the screen display, such as the transition of windows or the communication, on the other hand, the application browser 130 immediately returns the control to the execution engine 120 without removal of the current display.

When the key event is not any execution instruction, the application browser 130 actuates required GUI parts and logic parts corresponding to the key event (step S35). Examples of such key event include data input on the screen, manipulation of buttons, and specification of a range. Actuation of the required parts is readily attained by changing the values of the data items mapped to the respective parts as discussed previously with reference to FIG. 5.

The application browser 130 displays a resulting window and allows for manipulation on the window based on the screen definition. There is a possibility that the application browser is called by the execution engine 120 in a duplicated manner. The structure of the embodiment allows for generation of the multiple application browsers 130. The multiple application browsers 130 may individually execute the above series of processing to attain the parallel processing.

The information processing apparatus 100 of the first embodiment has advantages discussed below.

The first advantage is that the details of the substantial processing to be executed by the execution engine 120 and the application browser 130 maybe specified externally by the electronic documents including the flow definition 14, the screen definition 12, and the RELAX documents. This arrangement readily actualizes change and extension of the specification of the processing without modifying the software.

The second advantage is that the respective parts 131 used by the application browser 130 are constructed as individual modules. This structure facilitates addition of new parts and replacement of existing parts.

The third advantage is that the respective parts are not directly related to one another but are linked with one another via data items. Intermediation of the objects for association of the multiple parts ensures easy replacement of existing parts and addition of new parts.

The fourth advantage is that the XML application program running on the Web browser is independent of the platform and has high versatility.

B. Second Embodiment (Image Processing System)

The first embodiment regards the multi-purpose information processing system. A second embodiment of the present invention discussed below regards an image processing system as a concrete example of the XML application program.

B-1. System Construction

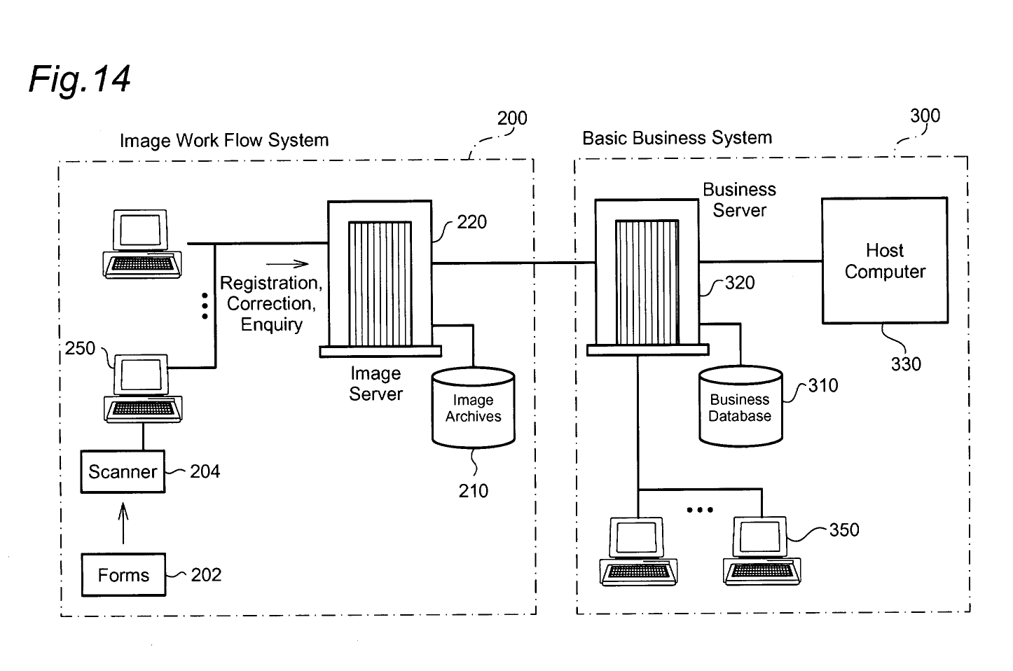

FIG. 14 schematically illustrates the construction of the image processing system in the second embodiment. The image processing system is used for transactions based on forms, such as transfer forms, in financial facilities. The system utilizes character data and numerical data (hereafter collectively referred to as ‘form data’) obtained from information included in each form and image data obtained by scanning the form for a corresponding transaction.

The image processing system includes an image work flow system 200 and a basic business system 300, which are connected to each other via a network. The image work flow system 200 executes registration, correction, and enquiry of the image data of the forms and the form data. The basic business system 300 takes charge of transactions. The transactions carried out by the basic business system 300 include those not utilizing any forms. For convenience, the following description regards only the transaction utilizing the form data.

The basic business system 300 has a business server 320 and a host computer 330, which may be separate or integrated. The business server 320 functions to manage business data required for transactions in a business database 310 and supply business data in response to requirements from clients 250 and 350. The business data include, for example, account information and a transaction record of each user. The host computer 330 actually carries out diverse transactions based on the business data.

The image work flow system 200 has an image server 220. The image server 220 functions to store the image data of the forms and the form data as image archives 210 and provide the image archives 210 in response to requirements from the clients 250 and 350.

The image data and the form data are input by the client 250 in the image work flow system 200 (hereafter referred to as the ‘image client’). The image client 250 actuates a scanner 204 to scan each form 202 and acquire image data of the form 202. The image client 250 makes the acquired image data subjected to OCR to obtain form data and registers the image data and the form data into the image server 220.

The registered form data are checked and corrected, if necessary, by another operator, who uses one image client 250 connecting with the image server 220. In response to the operator's instruction, the image client 250 displays a list of the image data and the form data, which are the object to be checked, in parallel. The operator compares the form data with the image data and detects any mistake of the form data. The operator corrects the detected mistakes of the form data, if any, and updates the contents of the image archives 210.

B-2. Software Configuration

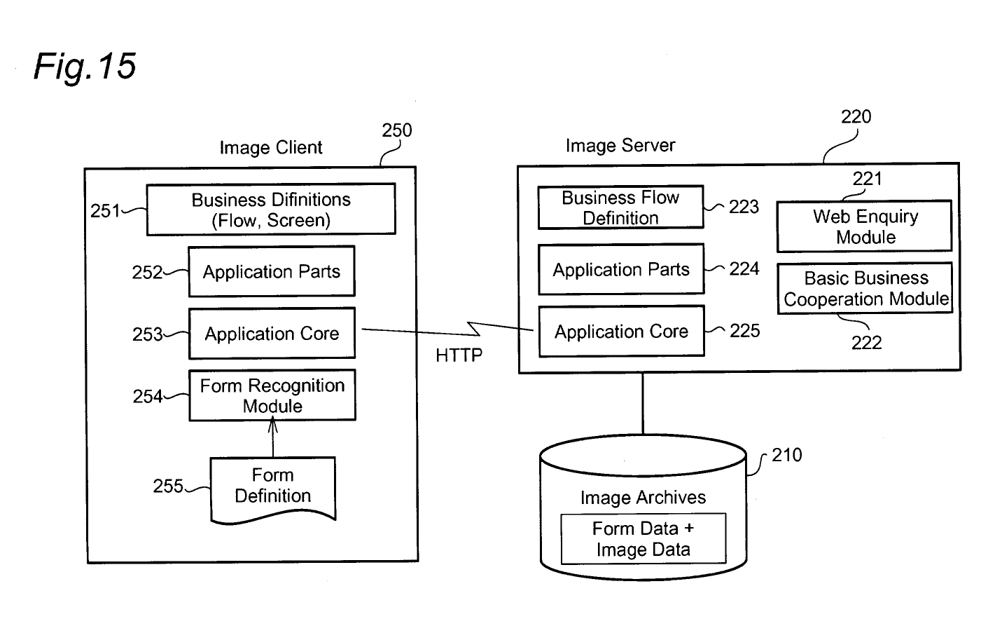

FIG. 15 shows the software configuration of the image work flow system 200. In the structure of the embodiment, both the image server 220 and the image client 250 carry out respective series of processing according to the XML application program. Functional blocks for activating the XML application program are thus built in the image server 220 and the image client 250.

The XML application program may be applied to only either one of the image server 220 and the image client 250, and may also be applicable to the basic business system 300.

The image server 220 has an application core 225. The application core 225 is the generic name of an execution engine, an application browser, and a message bus. As discussed in the first embodiment, the application core 225 is provided by a base applet on a Web browser.

The image server 220 also has application parts 224 and a business flow definition 223, which are used for the processing executed by the application core 225. The image server 220 does not take charge of the screen display and accordingly does not include the screen definition.

The business flow definition 223 specifies a series of processing to manage the image data and the form data received from the image client 250 in the form of the image archives 210 and a series of processing to provide the image data and the form data in response to requirements from the image clients 250 and other clients.

The image server 220 also includes a Web enquiry module 221 and a basic business cooperation module 222. The Web enquiry module 221 provides an image archive in the form of an HTML file in response to a requirement from a client, which does not deal with the XML application program. The basic business cooperation module 220 carries out series of processing that require cooperation with the basic business system 300. For example, simple comparison between the image data and the form data can not authenticate an account number. The basic business cooperation module 222 uses the basic business system 300 for authentication of the account number.

The image client 250 has an application core 253, application parts 252, and business definitions 251. Since the image client 250 takes charge of manipulation on the screen, the business definitions 251 include both a flow definition and a screen definition.

The image client 250 also includes a form recognition module 254. In the structure of the embodiment, the form recognition module 254 is provided as a software package activated independently of the XML application program. The form recognition module 254 may alternatively depend upon the XML application program. The form recognition module 254 makes the image data of each form subjected to OCR to obtain the form data. A target area of the OCR is specified for each form by a form definition 255.

The image client 250 carries out the processing other than the acquisition of the form data according to the XML application program. For example, the flow definition specifies acquisition of image data of each form, mapping of the image data of the form to the form data obtained by the form recognition module 254, and format conversion for storage in the image archives 210. The screen definition specifies manipulation windows required for such processing.

The flow definition also specifies series of processing for correction of the form data, for example, a process of providing the operator with the image data and the form data extracted from the image archives 210 and a process of accepting correction of the form data. The screen definition specifies windows used for such correction, for example, a window for enumerating the image data and the form data in a comparable manner and a window for accepting the correction.

Communication of the image client 250 with the image server 220 is based on an HTTP protocol in the structure of the embodiment. The electronic message described in the first embodiment is utilized for data transmission between the image client 250 and the image server 220. The application cores 253 and 225 refer to the RELAX documents to create and decode the electronic message.

B-3. Image Processing

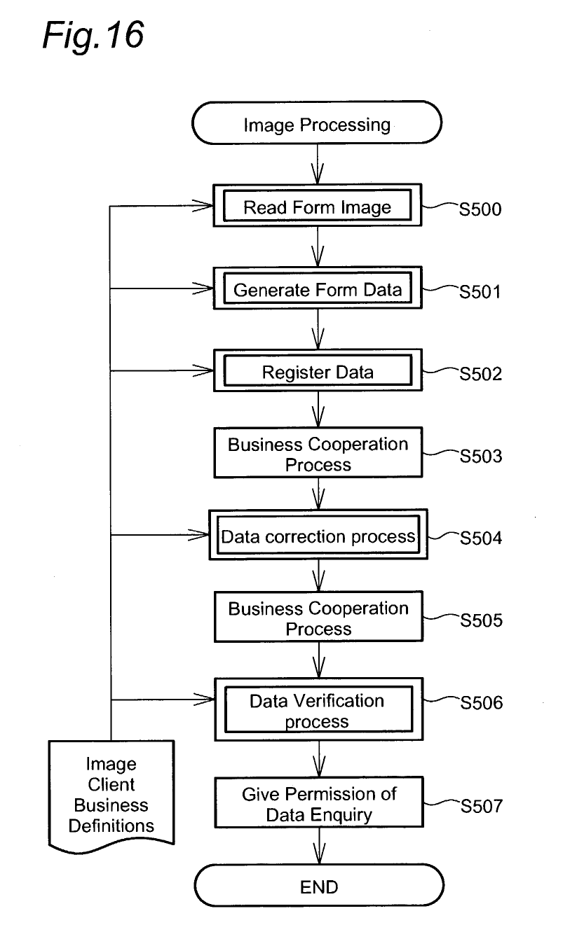

FIG. 16 is a flowchart showing general image processing, which is the whole work flow executed by the image client 250 and the image server 220. Double frames represent processes executed by the image client 250.

The image client 250 first reads a form image (step S500) and carries out form recognition to generate form data (step S501). The image client 250 then maps the form data to the image data and registers the mapping (step S502). The image client 250 stores the form data and the image data in a preset format and transmits the form data and the image data in the preset format to the image server 220. The image server 220 registers the received data into a predetermined area of the image archives 210.

The data may be stored in any of diverse formats and are stored in XML in this embodiment. Namely the form data are classified into respective items and recorded with specified tags in the XML format. The path names for storing the image data are also recorded in the XML format. This arrangement facilitates mapping of the form data to the image data and allows for consolidation. In the procedure of this embodiment, the data are registered with a status of non-completed correction and verification at this moment.

Subsequent to the registration of the data, the image server 220 carries out a business cooperation process (step S503). The business cooperation process includes, for example, authentication of the account number as described above.

On completion of the registration of the image data and the form data, the work flow shifts to a correction process (step S504). The correction process is executed by the image client 250. The terminal and the operator of the image client 250 may be different from those at the time of data registration. When the operator gives an instruction of ‘correction process’ to the image client 250, the image client 250 extracts data with the status of non-completed correction and verification from the data registered in the image archives 210. The operator compares the form data with the image data and makes required correction of the form data. The corrected data are transmitted to the image server 220. The image server 220 receives the corrected data and updates the contents of the image archives 210. Like at the time of data registration, the image server 220 then carries out the business cooperation process (step S505). At this moment, the data has a status of non-completed verification.

The work flow then shifts to a process of verifying the image data and the form data (step S506). The procedure of the processing follows that of the data correction process (step S504). The verification process re-checks the form data for any mistakes and may be omitted when not required.

When the image client 250 transmits the verified data to the image server 220, the image server 220 attaches a status of verification-completed to the received data and updates the contents of the image archives 210, so as to give permission for data enquiry (step S507). The above series of processing enables enquiry of the image data and the form data from the image client 250 and the basic business system 300.

The image client 250 carries out the above series of processing mainly according to the XML application program. The substantial contents of the processing are specified by the business definitions 251 of the image client 250. In the process of generating the form data (step S501), the XML application program is applied to the process of activating the form recognition module 254, which is independent of the XML application program, and the process of obtaining the result of recognition.

The image server 220 also carries out the above series of processing mainly according to the XML application program. The substantial contents of the processing are specified by the business flow definition 223 of the image server 220, although not being shown in FIG. 16.

The image processing system of the second embodiment applies the XML application program for the processing with the form data and the image data. There are a large variety of forms used for multiple transactions in various financial facilities, so that diverse series of image processing are required. The substantial contents of the processing according to the XML application program are specified by the business definitions 251 and the business flow definition 223. This arrangement ensures relatively easy customization and modification of the specification in the large variety of required processing.

The second embodiment regards the image processing in financial facilities. The principle of the invention is also applicable to a diversity of businesses using forms, for example, settlement of insurance in insurance companies.

C. Modifications

In the first and the second embodiments discussed above, the information processing apparatus 100, the image client 250, and the image server 220 are connected to the network. The XML application program may not be activated on a computer connecting with the network but may be activated on a standalone computer. In the case of activation on the standalone computer, the flow definition and the screen definition required for the processing may be stored in advance in the computer or may be supplied from a recording medium, such as a CD-ROM.

In the above embodiments, the XML application program is actualized by the software. One possible modification provides circuit structures that carry out the functions of the execution engine 120, the application browser 130, and the message bus 140, and thereby constructs the XML application program as the hardware. Such hardware construction also advantageously ensures relatively easy customization and modification of the processing without any significant change or replacement of the circuits.

Part of the functional blocks of the XML application program discussed in the first embodiment may be omitted. For example, only the basic functions of the execution engine 120, that is, the processing based on the flow definition 14, may depend upon the XML application program, while the processing of the electronic message 16 and the processing for the screen display may be independent of the XML application program. Alternatively only the processing of the electronic message 16 and the processing for the screen display may depend upon the XML application program.

The arrangement of the present invention ensures addition, modification, and customization of the information processing functions by simply changing the contents of the externally given electronic documents, without significantly modifying the software configuration or the hardware structure of the information processing apparatus itself.

The above embodiments and their applications are to be considered in all aspects as illustrative and not restrictive. There may be many modifications, changes, and alterations without departing from the scope or spirit of the main characteristics of the present invention. For example, the series of control processing discussed above may be actualized by a hardware construction, instead of the software configuration.

The scope and spirit of the present invention are indicated by the appended claims, rather than by the foregoing description.

What is claimed is:

1. An information processing apparatus, comprising:
multiple basic function modules that are constructed as individual elements and actualize preset basic functions;
a document input module that inputs an electronic document, which defines a specification of processing, in a format of identifying basic function modules to be used for the processing; and
an activation control module that analyzes the electronic document and sequentially activates said basic function modules identified by the analyzed electronic document.

2. An information processing apparatus in accordance with claim 1, wherein said multiple basic function modules include a window generation module that generates a window to be displayed on said information processing apparatus,
the electronic document defines a specification and a generation timing of the window, and
said activation control module activates said window generation module at the defined generation timing.

3. An information processing apparatus in accordance with claim 1, wherein the electronic document defines specifications of multiple series of processing and includes flow control information to determine an order of execution of the multiple series of processing, and
said activation control module activates said basic function modules identified by the electronic document in the order of execution according to the flow control information.

4. An information processing apparatus in accordance with claim 1, wherein said multiple basic function modules include a plurality of element display modules respectively representing display elements, which constitute a window to be displayed on said information processing apparatus,
the electronic document defines a class and a position of each of the display elements constituting the window, and
said activation control module activates said element display modules, based on the electronic document, so as to generate the window.

5. An information processing apparatus in accordance with claim 1, wherein said multiple basic function modules include a plurality of element operation modules, which respectively carry out preset operations with regard to data input into said information processing apparatus,
the electronic document defines an operation of the data, and
said activation control module activates said element operation module, based on the electronic document, so as to carry out the defined operation of the data.

6. An information processing apparatus, comprising:
multiple basic function modules that are constructed as individual elements and actualize preset basic functions; and
an object management module that manages predetermined objects, which are mapped to at least part of said basic function modules, with the mapping,
wherein said basic function module is activated in response to a status change of the object mapped thereto, and
in the case of a status change in at least part of the objects, said object management module notifies said basic function module mapped to the object of the status change.

7. An information processing apparatus in accordance with claim 6, wherein said multiple basic function modules include a plurality of element display modules respectively representing display elements, which constitute a window to be displayed on said information processing apparatus, and
said object management module comprises:
a common object management module that manages an object common to a plurality of windows; and
an individual object management module that manages an object related to a currently displayed window.

8. An information processing apparatus in accordance with claim 6, wherein each basic function module registers the mapping of the object to said basic function module into said object management module.

9. An information processing apparatus in accordance with claim 6, wherein said object management module comprises:
an object creation sub-module that, in response to activation of each basic function module, creates an object mapped to said activated basic function module; and
an object elimination sub-module that eliminates an object, which is not mapped to any of said activated basic function modules.

10. An information processing apparatus that is connected to a network and carry out a predetermined series of processing based on information transmitted via the network, said information processing apparatus comprising:
a document storage module that stores data to be included in an electronic message transmitted via the network, as well as a definition document, which defines a format of the data; and
an electronic message processing module that analyzes the definition document and creates or decodes the electronic message, based on the contents of the analyzed definition document.

11. An information processing apparatus in accordance with claim 10, said information processing apparatus further comprising:
a data management module that comprehensively manages multiple data relating to the predetermined series of processing,
wherein said electronic message processing module fetches data, which is to be included in the electronic message transmitted from said information processing apparatus, from said data management module.

12. An information processing apparatus in accordance with claim 10, said information processing apparatus further comprising:
a data management module that comprehensively manages multiple data relating to the predetermined series of processing,
wherein said electronic message processing module notifies said data management module of data, which is extracted from the electronic message received via the network.

13. An information processing apparatus in accordance with claim 10, wherein said document storage module stores a plurality of the definition documents,
said information processing apparatus further comprising:
a document input module that inputs an electronic document identifying definition documents to be used for multiple series of processing, which involve transmission of information via the network,
said electronic message processing module selectively using the definition documents identified by the electronic document according to currently executing processing.

14. A computer readable recording media in which a computer program that activates a computer to carry out a predetermined series of information processing is recorded, said computer program causing the computer to attain:
multiple basic function modules that are constructed as individual constituents and actualize preset basic functions;
a document input module that inputs an electronic document, which defines a specification of processing, in a format of identifying basic function modules to be used for the processing; and
an activation control module that analyzes the electronic document and sequentially activates said basic function modules identified by the analyzed electronic document.

15. A computer readable recording media in accordance with claim 14, wherein said multiple basic function modules include a window generation module that generates a window to be displayed on said computer,
the electronic document defines a specification and a generation timing of the window, and
said activation control module activates said window generation module at the defined generation timing.

16. A computer readable recording media in accordance with claim 14, wherein the electronic document defines specifications of multiple series of processing and includes flow control information to determine an order of execution of the multiple series of processing, and
said activation control module activates said basic function modules identified by the electronic document in the order of execution according to the flow control information.

17. A computer readable recording media in accordance with claim 14, wherein said multiple basic function modules include a plurality of element display modules respectively representing display elements, which constitute a window to be displayed on said computer,
the electronic document defines a class and a position of each of the display elements constituting the window, and
said activation control module activates said element display modules, based on the electronic document, so as to generate the window.

18. A computer readable recording media in accordance with claim 14, wherein said multiple basic function modules include a plurality of element operation modules, which respectively carry out preset operations with regard to data input into said computer,
the electronic document defines an operation of the data, and
said activation control module activates said element operation module, based on the electronic document, so as to carry out the defined operation of the data.

19. A computer readable recording media in which a computer program that activates a computer to carry out a predetermined series of information processing is recorded, said computer program causing the computer to attain:
multiple basic function modules that are constructed as individual constituents and actualize preset basic functions; and
an object management module that manages predetermined objects, which are mapped to at least part of said basic function modules, with the mapping,
wherein said basic function module is activated in response to a status change of the object mapped thereto, and
in the case of a status change in at least part of the objects, said object management module notifies said basic function module mapped to the object of the status change.

20. A computer readable recording media in accordance with claim 19, wherein said multiple basic function modules include a plurality of element display modules respectively representing display elements, which constitute a window to be displayed on said computer, and
said object management module comprises:
a common object management module that manages an object common to a plurality of windows; and
an individual object management module that manages an object related to a currently displayed window.

21. A computer readable recording media in accordance with claim 19, wherein each basic function module registers the mapping of the object to said basic function module into said object management module.

22. A computer readable recording media in accordance with claim 19, wherein said object management module comprises:
an object creation sub-module that, in response to activation of each basic function module, creates an object mapped to said activated basic function module; and
an object elimination sub-module that eliminates an object, which is not mapped to any of said activated basic function modules.

23. A computer readable recording media in which a computer program that activates a computer, which is connected to a network, to carry out a predetermined series of processing based on information transmitted via the network is recorded, said computer program causing the computer to attain:
a document management function that manages data to be included in an electronic message transmitted via the network, as well as a definition document, which defines a format of the data; and
an electronic message processing function that analyzes the definition document and creates or decodes the electronic message, based on the contents of the analyzed definition document.

24. A computer readable recording media in accordance with claim 23, said computer program comprising:
a data management module that comprehensively manages multiple data relating to the predetermined series of processing,
wherein said electronic message processing function fetches data, which is to be included in the electronic message to be transmitted, from said data management module.

25. A computer readable recording media in accordance with claim 23, said computer program comprising:
a data management module that comprehensively manages multiple data relating to the predetermined series of processing,
wherein said electronic message processing function notifies said data management module of data, which is extracted from the electronic message received via the network.

26. A computer readable recording media in accordance with claim 23, wherein said document management function manages a plurality of the definition documents,
said computer program further causing the computer to attain:
a document input function that inputs an electronic document identifying definition documents to be used for multiple series of processing, which involve transmission of information via the network,
said electronic message processing function selectively using the definition documents identified by the electronic document according to currently executing processing.

27. A computer readable recording media in accordance with claim 14, said computer program being constructed to run on a browser installed in the computer.

28. An information processing method that causes a computer to carry out a predetermined series of information processing, said information processing method comprising the steps of:
providing multiple basic function modules that are constructed as individual constituents and actualize preset basic functions;
inputting an electronic document, which defines a specification of processing, in a format of identifying basic function modules to be used for the processing; and
causing the computer to analyze the electronic document and sequentially activate said basic function modules identified by the analyzed electronic document.

29. An information processing method that causes a computer to carry out a predetermined series of information processing, said information processing method comprising the steps of:
providing multiple basic function modules that are constructed as individual constituents and actualize preset basic functions;
managing predetermined objects, which are mapped to at least part of said basic function modules, with the mapping; and
in the case of a status change in at least part of the objects, notifying said basic function module mapped to the object of the status change, so as to activate said mapped basic function module.

30. An information processing method that causes a computer, which is connected to a network, to carry out a predetermined series of processing based on information transmitted via the network, said information processing method comprising the steps of:
managing data to be included in an electronic message transmitted via the network, as well as a definition document, which defines a format of the data; and
analyzing the definition document and creating or decoding the electronic message, based on the contents of the analyzed definition document.

31. An image processing apparatus that carries out a preset series of image processing based on image data of a form, said image processing apparatus comprising:
multiple basic function modules that actualize preset basic functions with regard to the preset series of image processing;
a document input module that inputs an electronic document, which defines a specification of the image processing, in a format of identifying basic function modules to be used for the image processing; and
an activation control module that analyzes the electronic document and sequentially activates said basic function modules identified by the analyzed electronic document.

32. An image processing apparatus in accordance with claim 31, wherein said multiple basic function modules include a data extraction module that extracts either of character data and numerical data from the image data,
the electronic document specifies an area for the extraction from the image data and attribute of the extracted data, and
said activation control module activates said data extraction module based on the electronic document, so as to obtain data defined by the electronic document.

33. An image processing apparatus in accordance with claim 31, wherein said multiple basic function modules include:
an image display module that displays the image data;
a data display module that displays either of character data and numerical data extracted from the image data; and
a data modification module that modifies either of the character data and the numerical data,
the electronic document includes a display instruction to specify a display form of the image data and either of the character data and the numerical data and a modification instruction to specify a method of modifying either of the character data and the numerical data based on an external input, and
said activation control module activates said image display module and said data display module in response to the display instruction to actualize the specified display form, while activating said data modification module in response to the modification instruction to actualize the specified modification.
